(19) United States
(12) Patent Application Publication
(10) Pub. No.: US 2020/0164413 A1
(43) Pub. Date: May 28, 2020

(54) CLEANING FLUID

(71) Applicant: DAIDO METAL CO., LTD., NAGOYA-SHI, AICHI (JP)

(72) Inventor: Takashi IAI, INUYAMA-SHI, AICHI (JP)

(21) Appl. No.: 16/618,966

(22) PCT Filed: May 30, 2018
(86) PCT No.: PCT/JP2018/020724

§ 371 Date: Dec. 3, 2019

(30) Foreign Application Priority Data
Jun. 7, 2017 (JP) 2017-112898

(51) Int. Cl. B08B 7/04; B08B 5/02; B08B 3/04; B08B 3/02

(52) U.S. Cl. CPC B08B 7/04; B08B 5/02; B08B 3/04; B08B 2203/007; B08B 2203/02; B08B 2205/00; B08B 3/02

(57) ABSTRACT

A cleaning fluid includes a static liquid (13) at a first temperature, a dynamic liquid (16) that flows toward an object held in the static liquid (13), and a fine gas bubble group (22) formed from a gas at a second temperature that is different from the first temperature, the gas being entrapped by a flow of the dynamic liquid (16) and flowing toward the object. This can provide a cleaning fluid that exhibits a remarkably better cleaning effect than ever before.

### TECHNICAL FIELD

The present invention relates to a cleaning fluid containing a fine gas bubble group in a liquid.

### BACKGROUND ART

Patent Document 1 discloses a fine gas bubble generating device. When forming fine gas bubbles, a gas is blown into a liquid. The gas is heated at a higher temperature than for the liquid. Based on the difference in temperature, heat is lost from the gas and transferred to the liquid, the temperature within the gas bubbles decreases, and as a result the gas bubbles reduce in size.

### RELATED ART DOCUMENTS

### Patent Documents

Patent Document 1: Japanese Patent Application Laid-open No. 2008-168221

### SUMMARY OF THE INVENTION

### Problems to be Solved by the Invention

Fine gas bubbles are used for the treatment of tap water. Fine gas bubbles can be expected to separate a solid and have a microbicidal effect. Patent Document 1 does not refer to the cleaning effect of a fine gas bubble group.

An object of the present invention is to provide a cleaning fluid that exhibits a remarkably better cleaning effect than ever before.

### Means for Solving the Problems

According to a first aspect of the present invention, there is provided a cleaning fluid comprising a static liquid at a first temperature, a dynamic liquid that flows toward an object held in the static liquid, and a fine gas bubble group comprising a gas at a second temperature that is different from the first temperature, the gas being entrapped by a flow of the dynamic liquid and flowing toward the object.

According to a second aspect of the present invention, there is provided a cleaning fluid comprising a static liquid at a first temperature, a dynamic liquid at a second temperature that is different from the first temperature, the dynamic liquid flowing toward an object held in the static liquid, and a fine gas bubble group that is entrapped by a flow of the dynamic liquid and flows toward the object.

### Effects of the Invention

In accordance with the first aspect, since the surface of the object is in contact with the static liquid, it becomes close to the first temperature. When the fine gas bubbles make contact with the surface of the object, due to the difference between the first temperature and the second temperature the temperature changes locally within the fine gas bubbles. The local temperature change triggers local variation in volume within the fine gas bubbles, as a result more distortion than usual is generated in the fine gas bubbles, and the fine gas bubbles change significantly into a non-spherical shape. Compared with spherical fine gas bubbles, the non-spherical fine gas bubbles easily enter the border (the contour of the interface) between the surface of the object and a substance (for example a contaminant) adhering to the surface of the object. Detachment at the interface is thus promoted. Gas penetrates into the inside from the contour accompanying the progress of detachment. The substance becomes detached from the surface of the object. The substance is separated from the object. Furthermore, it is thought that, compared with spherical fine gas bubbles, non-spherical fine gas bubbles have local surface energy unevenly distributed due to the non-spherical shape, and the chemical bonding force between the non-spherical fine gas bubbles and the substance (for example a contaminant) adhering to the surface of the object is therefore great. As a result, the fine gas bubbles form an adsorbing body between themselves and the adhering substance, thus promoting the detachment from the surface of the object. In this way, the substance becomes detached from the surface of the object. The substance is separated from the object.

In accordance with the second aspect, in the vicinity of the surface of the object the static liquid at the first temperature and the dynamic liquid at the second temperature are mixed, thus causing a temperature distribution. The fine gas bubble group is exposed to the temperature distribution. As a result, the temperature changes locally within the fine gas bubbles. The local temperature change triggers local variation in volume within the fine gas bubbles, as a result more distortion than usual is generated in the fine gas bubbles, and the fine gas bubbles change significantly into a non-spherical shape. Compared with spherical fine gas bubbles, the non-spherical fine gas bubbles easily enter the border (the contour of the interface) between the surface of the object and a substance (for example a contaminant) adhering to the surface of the object. Detachment at the interface is thus promoted. The gas penetrates into the inside from the contour accompanying the progress of detachment. The substance becomes detached from the surface of the object. The substance is separated from the object. Furthermore, it is thought that, compared with spherical fine gas bubbles, the non-spherical fine gas bubbles have local surface energy unevenly distributed due to the non-spherical shape, and the chemical bonding force between the non-spherical fine gas bubbles and the substance (for example a contaminant) adhering to the surface of the object is therefore great. As a result, the fine gas bubbles form an adsorbing body between themselves and the adhering substance, thus promoting the detachment from the surface of the object. In this way, the substance becomes detached from the surface of the object. The substance is separated from the object.

### BRIEF DESCRIPTION OF DRAWINGS

FIG. 1 is a conceptual diagram showing an overall picture of a cleaning device related to one embodiment of the present invention.

FIG. 2 is a graph showing the relationship between temperature conditions and weight of swarf remaining.

FIG. 3 is a graph showing the relationship between temperature conditions and recovered oil concentration in a solvent.

### EXPLANATION OF REFERENCE NUMERALS AND SYMBOLS

11 Cleaning device
13 Static liquid
16 Dynamic liquid
22 Fine gas bubble group

### MODES FOR CARRYING OUT THE INVENTION

One embodiment of the present invention is explained below by reference to the attached drawings.

### (1) Cleaning Device Related to First Embodiment

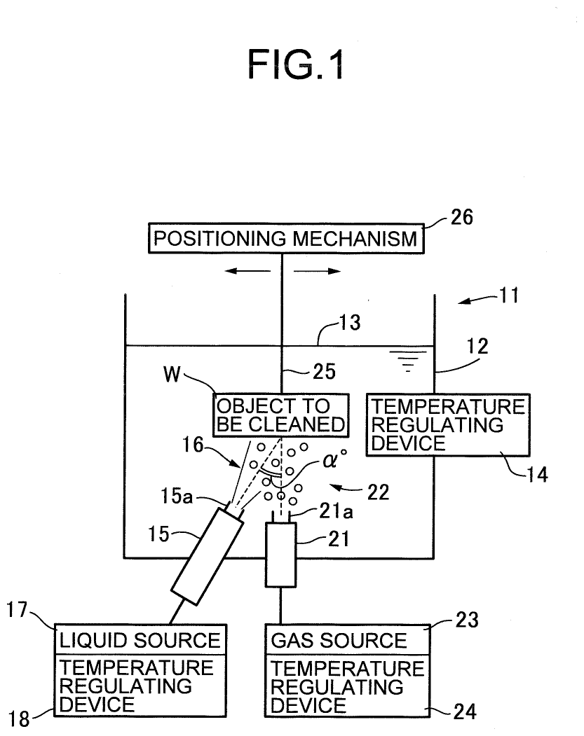

FIG. 1 shows an overall picture of a cleaning device related to a first embodiment of the present invention. The cleaning device 11 includes a liquid tank 12. The liquid tank 12 is filled with a liquid (hereinafter, called a ‘static liquid’) 13. The static liquid 13 may employ not only pure water but also a liquid that uses water or an organic solvent as a solvent and has an electrolyte, a surfactant, a gas, etc. dissolved therein. In the static liquid 13, natural convection based on temperature distribution is allowed, but it is desirable to exclude forced movement of the liquid by force.

A first temperature regulating device 14 is connected to the liquid tank 12. The first temperature regulating device 14 includes for example a heat exchanger that is immersed in the static liquid 13. The first temperature regulating device 14 regulates the temperature of the static liquid 13 within the liquid tank 12. When regulating the temperature, thermal energy is added to the static liquid 13 from the first temperature regulating device 14 (or the static liquid 13 is deprived thereof). Thermal energy (either plus or minus) may be transferred to the static liquid 13 by any method. Here, the temperature of the static liquid 13 is maintained at a first temperature by virtue of the first temperature regulating device 14. The first temperature is desirably set at no greater than 80 degrees Celsius. When the static liquid 13 is for example pure water or an aqueous solution, if the temperature of the pure water or the aqueous solution exceeds 80 degrees Celsius, the gas bubbles cannot maintain a high number density in a stable manner Here, the first temperature is set at 25 degrees Celsius. If the first temperature is set at close to room temperature, the energy that is consumed for maintaining the first temperature can be minimized.

A liquid flow generating device 15 is connected to the liquid tank 12. The liquid flow generating device 15 has a supply port 15a opening in the static liquid 13. The liquid flow generating device 15 makes a liquid flow into the static liquid 13 via the supply port 15a. The flow rate (flow volume) is set at 3.0 to 30.0 [L/min]. In this way, a liquid flow (hereinafter, called a ‘dynamic liquid’) 16 is formed in the static liquid 13. The dynamic liquid 16 includes a liquid that forcibly generates relative movement with respect to the static liquid 13. Such forced relative movement may be achieved in the form of a jet by means of an impeller.

A liquid source 17 is connected to the liquid flow generating device 15. The liquid source 17 supplies a liquid to the liquid flow generating device 15. The liquid may be the same liquid as the static liquid 13. A second temperature regulating device 18 is connected to the liquid source 17. The second temperature regulating device 18 regulates the temperature of the liquid of the liquid source 17. When regulating the temperature in this way, thermal energy is added to the liquid from the second temperature regulating device 18 (or the liquid is deprived thereof). Thermal energy (either plus or minus) may be transferred to the liquid by any method. Here, by virtue of the second temperature regulating device 18, the temperature of the dynamic liquid 16 is set at the first temperature, which is the same temperature as for the static liquid 13.

A gas bubble generating device 21 is connected to the liquid tank 12. The gas bubble generating device 21 has a supply port 21a opening in the static liquid 13. The gas bubble generating device 21 blows fine gas bubbles into the static liquid 13 via the supply port 21a. A flow of a fine gas bubble group 22 is formed in the static liquid 13. The fine gas bubbles include microbubbles and nanobubbles. The fine gas bubble group 22 may be a collection of gas bubbles having an average diameter of a defined value or less. The diameter of the gas bubbles may be set based on the diameter of a fine hole provided in the supply port 21a. The diameter of the fine hole is set at no greater than 50 μm. The diameter of the gas bubbles is preferably no greater than 1 μm. The concentration of the gas bubbles having a diameter of no greater than 1 μm is desirably 1×10⁶ or greater per milliliter.

A gas source 23 is connected to the gas bubble generating device 21. The gas source 23 supplies a gas to the gas bubble generating device 21. The gas is not limited to air, nitrogen, hydrogen, etc. and may be any type of gas. A third temperature regulating device 24 is connected to the gas source 23. The third temperature regulating device 24 regulates the temperature of the gas of the gas source 23. When regulating the temperature in this way, thermal energy is added to the gas from the third temperature regulating device 24 (or the gas is deprived thereof). Thermal energy (either plus or minus) may be transferred to the gas by any method. Here, by virtue of the third temperature regulating device 24 the temperature of the gas is set at a second temperature that is higher than the first temperature. The second temperature is set at for example 60 degrees Celsius.

The cleaning device 11 has a holder 25 for holding an object to be cleaned W. The holder 25 is immersed in the static liquid 13. The object to be cleaned W is fixed to the extremity of the holder 25. The object to be cleaned W is held in the static liquid 13. The supply port 15a of the liquid flow generating device 15 is directed toward the object to be cleaned W on the holder 25. In this way, a liquid flow is generated toward the object to be cleaned W. The supply port 21a of the gas bubbles generating device 21 is similarly directed to the object to be cleaned W on the holder 25. In this way, a flow of the fine gas bubble group 22 toward the object to be cleaned W is generated. Here, it is desirable for a vector showing the direction of the liquid flow and a vector showing the direction of the flow of the fine gas bubble group 22 to intersect each other on the object to be cleaned W at an acute angle. More preferably, it is desired for an angle α of the two vectors to be less than 90°. In accordance with such an angle α, the fine gas bubble group 22 can easily be entrapped by the liquid flow and reach the object to be cleaned W. In addition, the angle α may be set to a value that can realize entrapment of the fine gas bubble group 22 by the liquid flow according to the flow rate of the liquid flow and the flow rate of the fine gas bubble group 22. The flow of the fine gas bubble group 22 may be set to be vertically upward (a direction opposite to the direction of gravity).

A positioning mechanism 26 may be connected to the holder 25. The positioning mechanism 26 exerts a driving force that generates for example movement of the holder 25 along a horizontal plane. In accordance with such movement of the holder 25, the dynamic liquid 16 and the fine gas bubble group 22 can be directed to a target position on the object to be cleaned W. Cleaning of a face to be cleaned can be realized over a wide range. In addition, instead of the holder 25 being driven, the liquid tank 12 may be moved relative to the fixed holder 25. Alternatively, the orientation of the supply ports 15a and 21a may be changed with respect to the fixed holder 25 and liquid tank 12.

When the cleaning device 11 operates, the liquid flow generating device 15 generates a liquid flow at a first temperature toward the object to be cleaned W. The dynamic liquid 16 is generated in the static liquid 13. The gas bubble generating device 21 blows out the fine gas bubble group 22 at a second temperature that is higher than the first temperature toward the object to be cleaned W. The fine gas bubble group 22 thus blown out is entrapped by the flow of the dynamic liquid 16. In this way, the cleaning fluid of this embodiment is generated in accordance with a combination of the static liquid 13, the dynamic liquid 16 and the fine gas bubble group 22. Here, for example the first temperature is set at 25 degrees Celsius and the second temperature is set at 60 degrees Celsius.

Since the surface (face to be cleaned) of the object to be cleaned W is in contact with the static liquid 13, it becomes close to the first temperature. Due to the difference between the first temperature and the second temperature, the temperature changes locally within the fine gas bubbles, and the fine gas bubbles of the fine gas bubble group 22 make contact with the surface of the object to be cleaned W. The local temperature change triggers local variation in volume within the fine gas bubbles, as a result more distortion than usual is generated in the fine gas bubbles, and the fine gas bubbles change significantly into a non-spherical shape. Compared with spherical fine gas bubbles, the non-spherical fine gas bubbles easily enter the border (the contour of the interface) between the surface of the object to be cleaned W and a substance (for example a contaminant) adhering to the surface of the object to be cleaned W. Detachment at the interface is thus promoted. Gas penetrates into the inside from the contour accompanying the progress of detachment. The substance becomes detached from the surface of the object. The substance is separated from the object to be cleaned W. Furthermore, it is thought that, compared with spherical fine gas bubbles, non-spherical fine gas bubbles have local surface energy unevenly distributed due to the non-spherical shape, and the chemical bonding force between the non-spherical fine gas bubbles and the substance (for example a contaminant) adhering to the surface of the object to be cleaned W is therefore great. As a result, the fine gas bubbles form an adsorbing body between themselves and the adhering substance, thus promoting the detachment from the surface of the object to be cleaned W. In this way, the substance becomes detached from the surface of the object to be cleaned W. The substance is separated from the object to be cleaned W.

### (2) Cleaning Device Related to a Second Embodiment

A cleaning device related to the second embodiment has the same device arrangement as that of the cleaning device 11 of the first embodiment. However, the dynamic liquid 16 is set at a second temperature that is different from a first temperature of the static liquid 13, and the gas of the fine gas bubble group 22 is set at the first temperature, which is equal to that of the static liquid 13. Here, the second temperature is set higher than the first temperature. The first temperature may be set at 25 degrees Celsius 25 as above, and the second temperature may also be set at 60 degrees Celsius as above.

In this case, in the vicinity of the surface of the object to be cleaned W the static liquid 13 at the first temperature and the dynamic liquid 16 at the second temperature are mixed, thus causing a temperature distribution. The fine gas bubble group 22 is exposed to the temperature distribution. As a result, the temperature changes locally within the fine gas bubbles. The local temperature change triggers local variation in volume within the fine gas bubbles, as a result more distortion than usual is generated in the fine gas bubbles, and the fine gas bubbles change significantly into a non-spherical shape. Compared with spherical fine gas bubbles, the non-spherical fine gas bubbles easily enter the border (the contour of the interface) between the surface of the object to be cleaned W and a substance (for example a contaminant) adhering to the surface of the object to be cleaned W. Detachment at the interface is thus promoted. The gas penetrates into the inside from the contour accompanying the progress of detachment. The substance becomes detached from the surface of the object to be cleaned W. The substance is separated from the object to be cleaned W. Furthermore, it is thought that, compared with spherical fine gas bubbles, the non-spherical fine gas bubbles have local surface energy unevenly distributed due to the non-spherical shape, and the chemical bonding force between the non-spherical fine gas bubbles and the substance (for example a contaminant) adhering to the surface of the object to be cleaned W is therefore great. As a result, the fine gas bubbles form an adsorbing body between themselves and the adhering substance, thus promoting the detachment from the surface of the object to be cleaned W. In this way, the substance becomes detached from the surface of the object to be cleaned W. The substance is separated from the object to be cleaned W.

### (3) Verification

The present inventors have carried out verification in accordance with the cleaning device 11 related to the first embodiment and the second embodiment described above. In the verification, temperature conditions were examined for the static liquid 13, the dynamic liquid 16 and the fine gas bubble group 22. The static liquid 13 employed pure water. For the examination, the liquid tank 12 was filled with 50 L of pure water. The temperature (=TL) of the pure water was set at 25 degrees Celsius. Pure water was supplied to the liquid flow generating device 15 from the liquid source 17. The temperature (first temperature TD) of the pure water was regulated. The flow rate of the dynamic liquid 16 was set at 20.0 [L/min].

Atmosphere (air) was supplied to the gas bubble generating device 21 from the gas source 23. The temperature (second temperature TB) of the air was regulated. The amount of fine gas bubbles was set at on the order of 1×10⁶ per milliliter. The diameter of the fine gas bubbles was set at 500 nm or less, and the average diameter was substantially 200 nm. A film having pores with a diameter of 500 nm or less was used when forming the fine gas bubbles. The fine gas bubble group 22 was continuously blown into the static liquid 13 over 10 minutes.

The holder 25 employed a basket. A machine component was mounted in the basket as the object to be cleaned W. The machine component was formed from ten cubic metal bodies having a side of 50 [mm]. Swarf at the time of machining became attached to the surface of the machine component together with oil. After carrying out cleaning for 10 minutes, the amount of swarf and the amount of oil remaining on the surface of the machine component were measured. When measuring the amount of swarf, the machine component cleaned as above was subjected to high pressure cleaning. Swarf thus washed away was collected on a filter paper. The weight [milligrams] of swarf thus collected was measured using an electronic balance. On the other hand, when measuring the amount of oil, the cleaned machine component was immersed in a solvent. The concentration [ppm] of oil dissolved in the solvent was measured.

When examining the temperature conditions, six types of conditions were set as follows.

TABLE 1

| | Temperature of | Temperature of | Temperature of |
|---|---|---|---|
| | static liquid | dynamic liquid | gas bubbles |
| | TL | TD | TB |
| Conditions 1 | 25° C. | 25° C. | 40° C. |
| Conditions 2 | 25° C. | 25° C. | 60° C. |
| Conditions 3 | 25° C. | 40° C. | 25° C. |
| Conditions 4 | 25° C. | 60° C. | 25° C. |
| Conditions 5 | 25° C. | 60° C. | 40° C. |
| Conditions 6 | 25° C. | 40° C. | 60° C. |

In all of the conditions, the temperature TL of the static liquid 13 was set at 25 degrees Celsius (=first temperature).

In Conditions 1 and Conditions 2 the temperature TB of the gas bubbles was set higher than the temperature TD of the dynamic liquid 16. Here, the temperature TD of the dynamic liquid 16 was set at the first temperature. The temperature TB of the gas bubbles was set at two second temperatures. In Conditions 1 a temperature difference of 15 degrees Celsius was set between the temperature TD of the dynamic liquid 16 and the temperature TB of the gas bubbles. In Conditions 2 a temperature difference of 35 degrees Celsius was set between the temperature TD of the dynamic liquid 16 and the temperature TB of the gas bubbles.

In Conditions 3 and Conditions 4 the temperature TB of the gas bubbles was set to be lower than the temperature TD of the dynamic liquid 16. Here, the temperature TB of the gas bubbles was set at the first temperature. In Conditions 3 a temperature difference of 15 degrees Celsius was set between the temperature TD of the dynamic liquid 16 and the temperature TB of the gas bubbles. In Conditions 4 a temperature difference of 35 degrees Celsius was set between the temperature TD of the dynamic liquid 16 and the temperature TB of the gas bubbles.

In Conditions 5 and Conditions 6 the temperature TL of the static liquid 13, the temperature TD of the dynamic liquid 16, and the temperature TB of the gas bubbles were set to be different temperatures from each other. A temperature difference of 20 degrees Celsius was set between the temperature TD of the dynamic liquid 16 and the temperature TB of the gas bubbles. In Conditions 5 the temperature TD of the dynamic liquid 16 was set higher than the temperature TB of the gas bubbles. In Conditions 6 the temperature TB of the gas bubbles was set higher than the temperature TD of the dynamic liquid 16.

When examining the temperature conditions, the present inventors set two types of Comparative conditions. In both of the Comparative conditions the temperature TL of the static liquid 13, the temperature TD of the dynamic liquid 16, and the temperature TB of the gas bubbles were set equal. In Comparative conditions 1 all of the temperatures TL, TD and TB were set equal at 25 degrees Celsius, and in Comparative conditions 2 all of the temperatures TL, TD and TB were set equal at 50 degrees Celsius.

TABLE 2

| | Temperature of | Temperature of | Temperature of |
|---|---|---|---|
| | static liquid | dynamic liquid | gas bubbles |
| | TL | TD | TB |
| Comparative | 25° C. | 25° C. | 25° C. |
| Conditions 1 | | | |
| Comparative | 50° C. | 50° C. | 50° C. |
| Conditions 2 | | | |

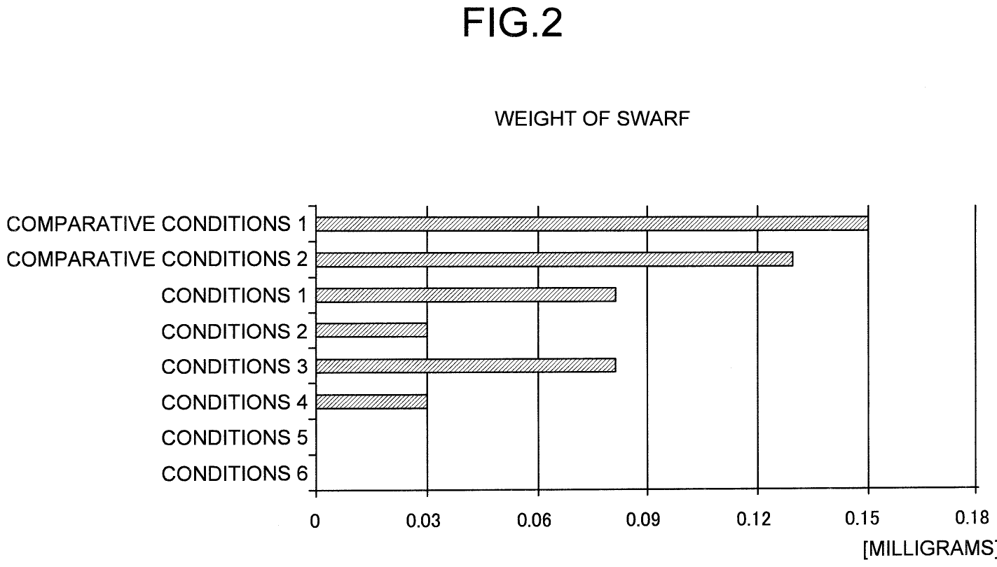

From the results of observation, as shown in FIG. 2, it was confirmed that in temperature conditions 1 to 4, in which either one of the temperature TD of the dynamic liquid 16 and the temperature TB of the gas bubbles was different from the temperature TL of the static liquid 13, the removal of swarf was greatly promoted compared with Comparative conditions 1 and 2. In particular, as is clear from a comparison between Conditions 1 and 2 and a comparison between Conditions 3 and 4, it was confirmed that when the difference between the temperature TD of the dynamic liquid 16 and the temperature TB of the gas bubbles was increased, the cleaning effect for swarf was enhanced. Moreover, it was confirmed as observed from Conditions 5 that, compared with Conditions 4, when the temperature TB of the gas bubbles was further increased away from the temperature TL of the static liquid 13, and the temperature TL of the static liquid 13, the temperature TD of the dynamic liquid 16, and the temperature TB of the gas bubbles were all different from each other, the removal of swarf was further promoted. Similarly, it was confirmed as observed from Conditions 6 that, compared with Conditions 2, when the temperature TD of the dynamic liquid 16 was further increased away from the temperature TL of the static liquid 13, and the temperature TL of the static liquid 13, the temperature TD of the dynamic liquid 16, and the temperature TB of the gas bubbles were all different from each other, the removal of swarf was further promoted.

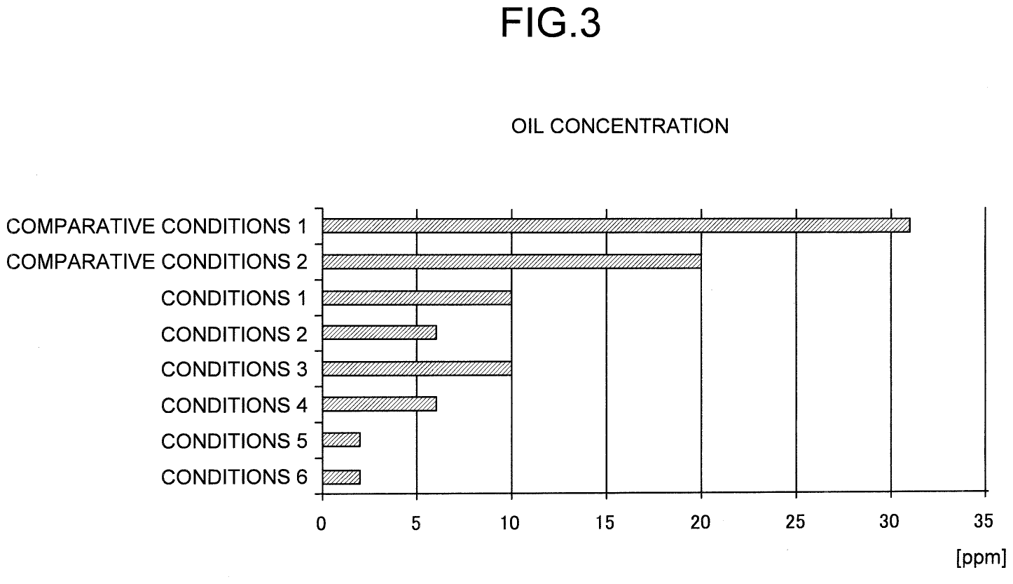

As shown in FIG. 3, it was confirmed that in Conditions 1 to 4, in which either one of the temperature TD of the dynamic liquid 16 and the temperature TB of the gas bubbles was different from the temperature TL of the static liquid 13, compared with Comparative conditions 1 and 2 the removal of oil was greatly promoted. In particular, as is clear from a comparison between Conditions 1 and 2 and a comparison between Conditions 3 and 4, it was confirmed that when the difference in temperature between the temperature TD of the dynamic liquid 16 and the temperature TB of the gas bubbles was increased, the cleaning effect for oil was enhanced. Moreover, it was confirmed as observed from Conditions 5 that, compared with Conditions 4, when the temperature TB of the gas bubbles was further increased away from the temperature TL of the static liquid 13, and the temperature TL of the static liquid 13, the temperature TD of the dynamic liquid 16, and the temperature TB of the gas bubbles were all different from each other, the removal of oil was further promoted. Similarly, it was confirmed as observed from Conditions 6 that, compared with Conditions 2, when the temperature TD of the dynamic liquid 16 was further increased away from the temperature TL of the static liquid 13, and the temperature TL of the static liquid 13, the temperature TD of the dynamic liquid 16, and the temperature TB of the gas bubbles were all different from each other, the removal of oil was further promoted.

1. A cleaning fluid comprising
a static liquid at a first temperature,
a dynamic liquid that flows toward an object held in the static liquid, and
a fine gas bubble group comprising a gas at a second temperature that is different from the first temperature, the gas being entrapped by a flow of the dynamic liquid and flowing toward the object.

2. A cleaning fluid comprising
a static liquid at a first temperature,
a dynamic liquid at a second temperature that is different from the first temperature, the dynamic liquid flowing toward an object held in the static liquid, and
a fine gas bubble group that is entrapped by a flow of the dynamic liquid and flows toward the object.
